(19) United States
(12) Patent Application Publication
(10) Pub. No.: US 2007/0005345 A1
(43) Pub. Date: Jan. 4, 2007

(54) Generating Chinese language couplets

(75) Inventors: Ming Zhou, Beijing (CN); Heung-Yeung Shum, Bellevue, WA (US)

Correspondence Address: WESTMAN CHAMPLIN (MICROSOFT CORPORATION), SUITE 1400, 900 SECOND AVENUE SOUTH, MINNEAPOLIS, MN, 55402-3319, US

(73) Assignee: Microsoft Corporation, Bellevue, WA (US)

(21) Appl. No.: 11/173,892

(22) Filed: Jul. 1, 2005

(51) Int. Cl. G06F 17/21

(52) U.S. Cl. 704/10

(57) ABSTRACT

An approach of constructing Chinese language couplets, in particular, a second scroll sentence given a first scroll sentence is presented. The approach includes constructing a language model, a word translation-like model, and word association information such as mutual information values that can be used later in generating second scroll sentences of Chinese couplets. A Hidden Markov Model (HMM) is used to generate candidates. A Maximum Entropy (ME) model can then be used to re-rank the candidates to generate one or more reasonable second scroll sentences give a first scroll sentence.

### BACKGROUND OF THE INVENTION

Artificial intelligence is the science and engineering of making intelligent machines, especially computer programs. Applications of artificial intelligence include game playing, such as chess, and speech recognition.

Chinese antithetical couplets called “dui4-lian2” (in Pinyin) are considered an important Chinese cultural heritage. The teaching of antithetical couplets was an important method of teaching traditional Chinese for thousands of years. Typically, an antithetical couplet includes two phrases or sentences written as calligraphy on vertical red banners, typically placed on either side of a door or in a large hall. Such couplets are often displayed during special occasions such as weddings or during the Spring Festival, i.e. Chinese New Year. Other types of couplets include birthday couplets, elegiac couplets, decoration couplets, professional or other human association couplets, and the like. Couplets can also be accompanied with horizontal streamers, typically placed above a door between the vertical banners. A streamer generally includes the general topic of the associated couplet.

Chinese antithetical couplets use condensed language, but have deep and sometimes ambivalent or double meaning. The two sentences making up the couplet can be called the “first scroll sentence” and the “second scroll sentence”.

An example of a Chinese couplet is [symbol] and [symbol] , where the first scroll sentence is [symbol] and the second scroll sentence is [symbol] . The correspondence between individual words of the first and second sentences is shown as follows:

[symbol]

(sea)-------------- [symbol] (sky) [symbol]
(wide)------------- [symbol] (high) [symbol]
(allows)----------- [symbol] (enable) [symbol]
(fish)-------------- [symbol] (bird) [symbol]
(jump)------------- [symbol] (fly)

Antithetical couplets can be of different length. A short couplet can include one or two characters while a longer couplet can reach several hundred characters. The antithetical couplets can also have diverse forms or relative meanings. For instance, one form can include first and second scroll sentences having the same meaning. Another form can include scroll sentences having the opposite meaning.

However, no matter which form, Chinese couplets generally conform to the following rules or principles:

Principle 1: The two sentences of the couplet generally have the same number of words and total number of Chinese characters. Each Chinese character has one syllable when spoken. A Chinese word can have one, two or more characters, and consequently, be pronounced with one, two or more syllables. Each word of a first scroll sentence should have the same number of Chinese characters as the corresponding word in the second scroll sentence.

Principle 2: Tones (e.g. “Ping” ( [symbol] and [symbol] ( [symbol] ) in Chinese) are generally coinciding and harmonious. The traditional custom is that the character at the end of first scroll sentence should be [symbol] (called tone “Ze” in Chinese). This tone is pronounced in a sharp downward tone. The character at the end of the second scroll sentence should be [symbol] (called tone “Ping” in Chinese). This tone is pronounced with a level tone.

Principle 3: The parts of speech of words in the second sentence should be identical to the corresponding words in the first scroll sentence. In other words, a noun in the first scroll sentence should correspond to a noun in the second scroll sentence. The same would be true for a verb, adjective, number-classifier, adverb, and so on. Moreover, the corresponding words must be in the same position in the first scroll sentence and the second scroll sentence.

Principle 4: The contents of the second scroll sentence should be mutually inter-related with the first scroll sentence and the contents cannot be duplicated in the first and second scroll sentences.

Chinese-speaking people often engage in creating new couplets as a form of entertainment. One form of recreation is one person makes up a first scroll sentence and challenges others to create on the spot an appropriate second scroll sentence. Thus, creating second scroll sentences challenges participants' linguistic, creative, and other intellectual capabilities.

Accordingly, automatic generation of Chinese couplets, in particular, second scroll sentences given first scroll sentences, would be an appropriate and well-regarded application of artificial intelligence.

The discussion above is merely provided for general background information and is not intended to be used as an aid in determining the scope of the claimed subject matter.

### SUMMARY OF THE INVENTION

An approach to generate a second scroll sentence given a first scroll sentence of Chinese couplets is presented. The approach includes constructing a language model, a word translation-like model, and word association information such as mutual information values that can be used later in generating second scroll sentences of Chinese couplets. A Hidden Markov Model (HMM) is presented that can be used to generate candidates based on the language model and the word translation-like model. Also, the word association values or scores of a sentence (such as mutual information) can be used to improve candidate selection. A Maximum Entropy (ME) model can then be used to re-rank the candidates to generate one or more reasonable second scroll sentences give a first scroll sentence.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is a block diagram of one computing environment in which the present invention can be practiced.

FIG. 2 is an overview flow diagram illustrating broad aspects of the present invention.

FIG. 3 is a block diagram of a system for augmenting a lexical knowledge base with information useful in generating second scroll sentences.

FIG. 4 is a block diagram for a system for performing second scroll sentence generation.

FIG. 5 is a flow diagram illustrating augmentation of the lexical knowledge base.

FIG. 6 is a flow diagram illustrating generation of second scroll sentences.

### DETAILED DESCRIPTION OF ILLUSTRATIVE EMBODIMENTS

Automatic generation of Chinese couples is an application of natural language processing, in particular, a demonstration of artificial intelligence.

A first aspect of the approach provides for augmenting a lexical knowledge base with information, such as probability information, that is useful in generating second scroll sentences given first scroll sentences of Chinese couplets. In a second aspect, a Hidden Markov Model (HMM) is introduced that is used to generate candidate second scroll sentences. In a third aspect, a Maximum Entropy (ME) model is introduced to re-rank the candidate second scroll sentences.

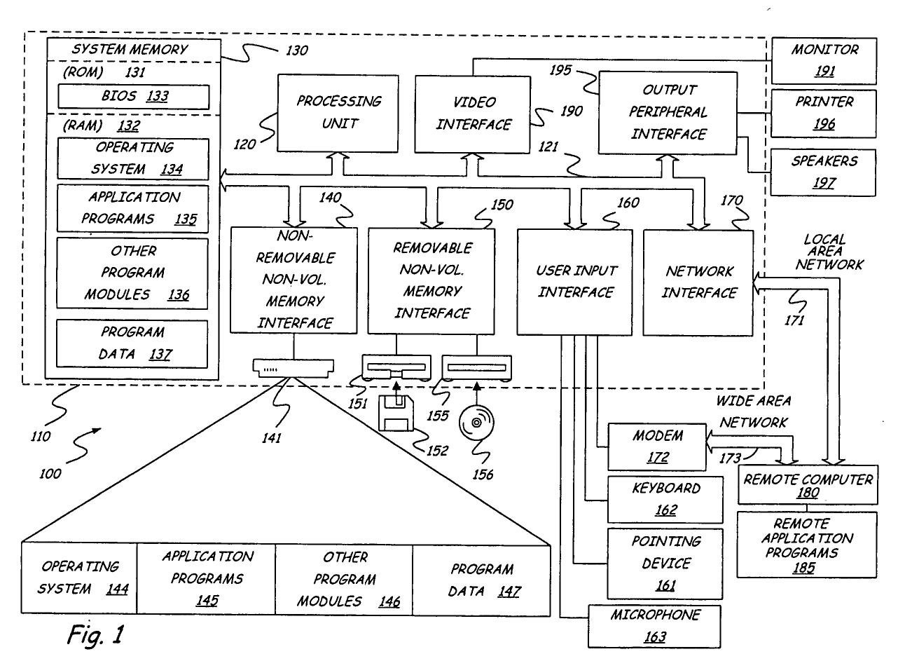

Before addressing further aspects of the approach, it may be helpful to describe generally computing devices that can be used for practicing the inventions. FIG. 1 illustrates an example of a suitable computing system environment 100 on which the inventions may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The inventions are operational with numerous other general purpose or special purpose computing system environments or configurations. Examples of well known computing systems, environments, and/or configurations that may be suitable for use with the inventions include, but are not limited to, personal computers, server computers, hand-held or laptop devices, multiprocessor systems, microprocessor-based systems, set top boxes, programmable consumer electronics, network PCs, minicomputers, mainframe computers, telephone systems, distributed computing environments that include any of the above systems or devices, and the like.

The inventions may be described in the general context of computer-executable instructions, such as program modules, being executed by a computer. Generally, program modules include routines, programs, objects, components, data structures, etc. that perform particular tasks or implement particular abstract data types. Those skilled in the art can implement the description and figures provided herein as processor executable instructions, which can be written on any form of a computer readable medium.

The inventions may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the inventions include a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

Overview

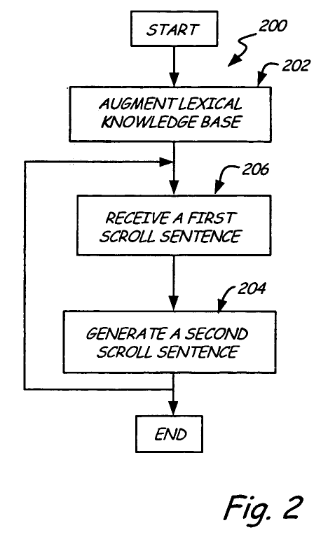

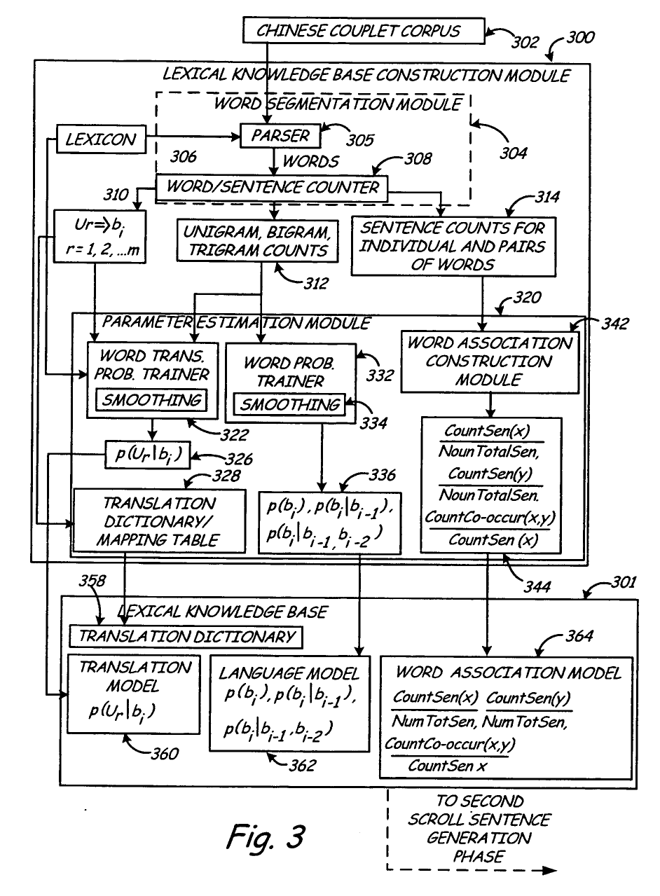

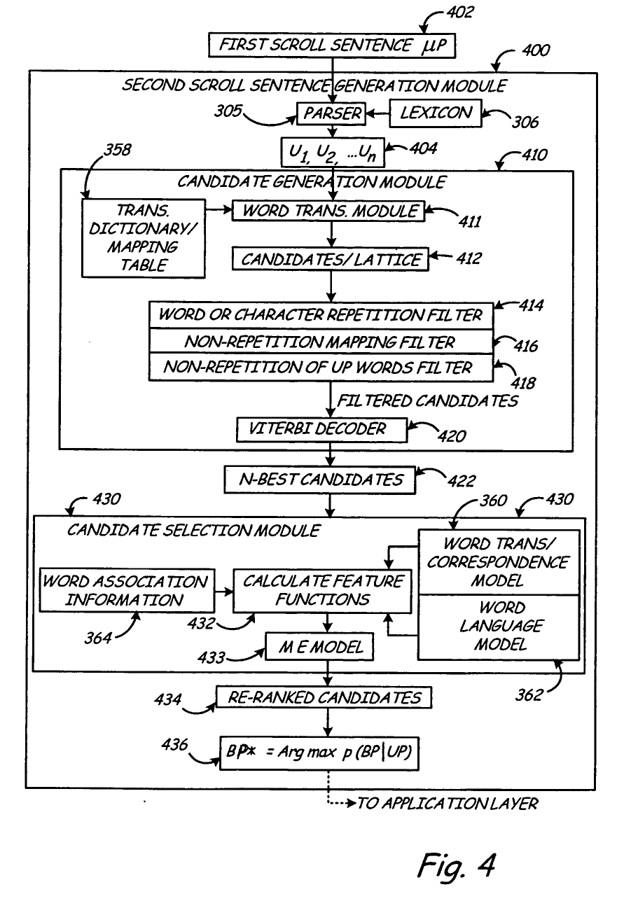

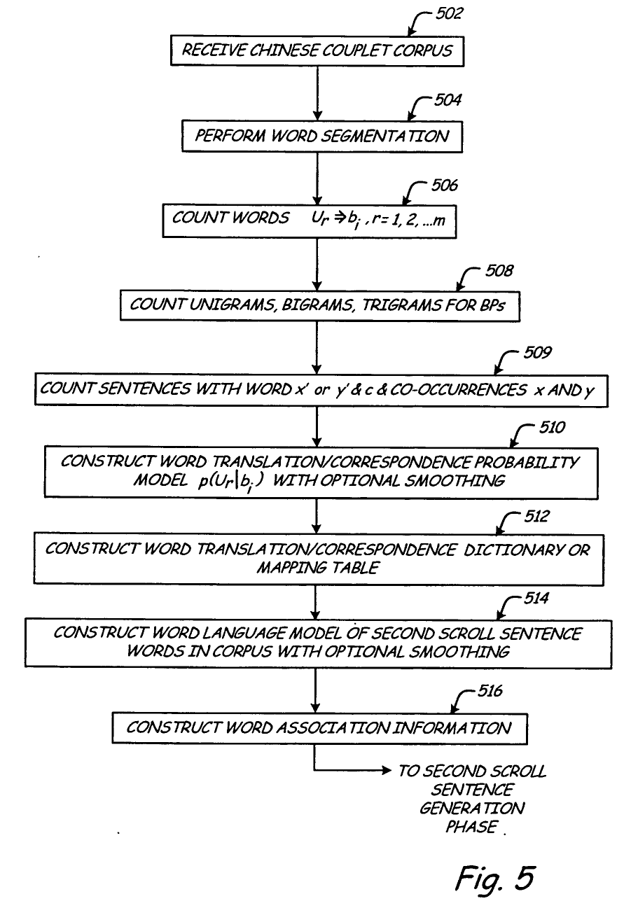

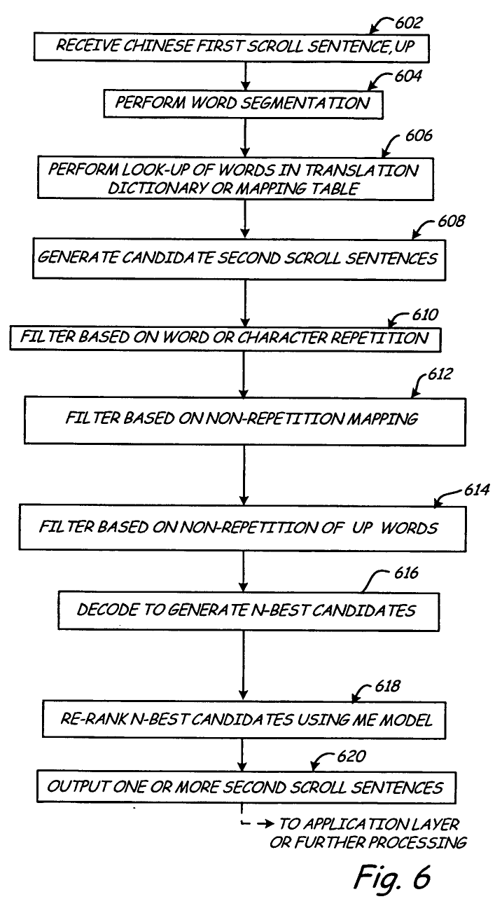

The present inventions relate to natural language couplets, in particular, generating second scroll sentences given first scroll sentences of a couplet. To do so, lexical information is constructed that can be later accessed to perform second scroll sentence generation. FIG. 2 is an overview flow diagram illustrating broad method 200 comprising step 202 of augmenting a lexical knowledge base with information used later to perform step 204 of generating second scroll sentences appropriate for a received first scroll sentence indicated at 206. FIGS. 3 and 4 illustrate systems for performing steps 202 and 204, respectively. FIGS. 5 and 6 are flow diagrams generally corresponding to FIGS. 3 and 4, respectively.

Given the first sentence, denoted as UP={u₁, u₂, . . . , uₙ}, UP means “upper phrase” (first sentence), an objective is to seek a sentence, denoted as BP={b₁, b₂, . . . , bₙ} so that p(BP|UP) is maximized. BP means “bottom phrase” (second sentence). Formally, the second scroll sentences that maximizes p(BP|UP) can be expressed as follows:

$$BP *= {arg max}_{BP} p ( BP \vert UP ) \qquad Eq . 1$$

According to Bayes' theorem,

$$p ( BP \vert UP ) = \frac{p ( UP \vert BP ) p ( BP )}{p ( UP )}$$

so that

$$\begin{matrix}BP *= {arg max}_{BP} ( BP \vert UP ) \\ = {arg max}_{BP} p ( UP \vert BP ) p ( BP )\end{matrix} \qquad Eq . 2$$

where the expression P(BP) is often called the language model and P(UP|BP) is often called the translation model. The values for P(BP) can be considered the probability of the second scroll sentence and P(UP|BP) can be considered the translation probability of UP into BP.
Translation Model

In a Chinese couplet, there is generally direct one-one mapping between uᵢ and bᵢ, which are corresponding words in the first and second scroll sentences, respectively. Thus, the i^{th} word in UP is translated into or corresponds with the i^{th} word in BP. Assuming the independent translation of words, the word translation model can be expressed as follows:

$$p ( UP \vert BP ) = {\prod }_{i = 1}^{n} p ( {u}_{i} \vert {b}_{i} ) \qquad Eq . 3$$

where n is the number of words in one of the scroll sentences. Here p(uᵢ|bᵢ) represents word translation probability, which is commonly called emission probability in HMM models.

Values of p(uᵢ|bᵢ) can be estimated based on a training corpus composed of Chinese couplets found in various literature resources, such as some sentences found in Tang Dynasty poetry (e.g. the inner two sentences of some four-sentence poems, or inner four sentences of some eight-sentence poems), and can be expressed with the following equation:

$$p ( {u}_{i} \vert {b}_{i} ) = \frac{count ( {u}_{r} , {b}_{i} )}{{\sum }_{r = 1}^{m} count ( {u}_{r} , {b}_{i} )} \qquad Eq . 4$$

where m is the number of distinct words per i^{th} state that can be mapped to each word bᵢ.

However, issues of data sparseness can arise because the training data or corpus of existing Chinese couplets is of limited size. Thus, some words may not exist in first scroll sentences of the training data. Also, some words in first scroll sentences can have scarce corresponding words in second scroll sentences. To overcome issues of data sparseness, smoothing can be applied as follows:

(1) Given a Chinese word bᵢ, for a word pair <uᵣ,bᵢ> seen in the training data, the emission probability of uᵣ given bᵢ can be expressed as follows:
p(uᵣ|bᵢ)=p(uᵣ|bᵢ)×(1−x) Eq. 5
where p(uᵣ|bᵢ) is the translation probability, which can be calculated using Equation 4 and x=Eᵢ/Sᵢ, where Eᵢ is the number of words appearing only once corresponding to bᵢ and Sᵢ is the total number of words in first scroll sentences of the training corpus corresponding to bᵢ in the training data.
(2) For first scroll sentence words uᵣ not encountered in the training corpus, the emission probability can be expressed as follows:

$$p ( {u}_{r} \vert {c}_{i} ) = \frac{x}{M - {m}_{i}} \qquad Eq . 6$$

where M is the number of all the words (defined in a lexicon) that can be linguistically mapped with bᵢ and mᵢ is the number of distinct words that can be mapped to bᵢ in the training corpus. For a given Chinese lexicon, denoted as Σ, the set of words denoted as Lᵢ that can be linguistically mapped with bᵢ should meet the following constraints:
Any word in Lᵢ should have identical lexical category or part of speech with bᵢ;
Any word in Lᵢ should have identical number of characters with bᵢ;
Any word in Lᵢ should have a legal semantic relation with bᵢ. The legal semantic relations include synonyms, similar meaning, opposite meaning, and the like.
   (3) As a special case of (2), for the new word bᵢ, which is not encountered in the training corpus, the translation probability can be expressed as follows:
   p(uᵣ|b₁)=1/M Eq. 7
   Language Model

A trigram model can be constructed from the training data to estimate the language model P(BP), which can be expressed as follows:

$$p ( BP ) = p ( {b}_{1} ) \times p ( {b}_{2} \vert {b}_{1} ) {\prod }_{i = 3}^{n} p ( {b}_{i} \vert {b}_{i - 1} , {b}_{i - 2} ) \qquad Eq . 8$$

where unigram values p(bᵢ), bigrams values p(b₂|b₁), and trigrams values p(bᵢ|bᵢ₋₁, b_{I-2}) can be used to estimate the likelihood of the sequence bᵢ₋₂, bᵢ₋₁, bᵢ. These unigram, bigram, and trigram probabilities are often called transition probabilities in HMM models and can be expressed using Maximum Likelihood Estimation as follows:

$$\begin{matrix}p ( {b}_{i} ) = \frac{count ( {b}_{i} )}{T} & Eq . 9 \\ p ( {b}_{i} \vert {b}_{i - 1} , {b}_{i - 2} ) = \frac{count ( {b}_{i} , {b}_{i - 1} , {b}_{i - 2} )}{count ( {b}_{i - 1} , {b}_{i - 2} )} & Eq . 10 \\ p ( {b}_{i} \vert {b}_{i - 1} ) = \frac{count ( {b}_{i} , {b}_{i - 1} )}{count ( {b}_{i - 1} )} & Eq . 11\end{matrix}$$

where T is the number of words in the second scroll sentences of the training corpus.

As with the translation model described above, issues of data sparseness are applicable with respect to the language model. Thus, a linear interpolation method can be applied smooth the language model as follows:
p(bᵢ|bᵢ₋₁,bᵢ₋₂)=λ₁p(bᵢ)+λ₂p(bᵢ|bᵢ₋₁)+λ₃p(bᵢ|bᵢ₋₁,bᵢ₋₂) Eq. 12
where coefficients λ₁, λ₂, λ₃ are obtained from training the language model.
Word Association Scores (e.g. Mutual Information)

In addition, to the language model and the translation model above described, word association scores such as mutual information (MI) values can be used in generating appropriate second scroll sentences. For the second scroll sentence, denoted as BP={b₁, b₂, . . . , bₙ}, the MI score of BP is the sum of MI of all the word pairs of BP. The mutual information of each pair of words is computed as follows:

$$I ( X ; Y ) = {\sum }_{x}^{} {\sum }_{y}^{} p ( x , y ) log \frac{p ( x , y )}{p ( x ) p ( y )} \qquad Eq . 12$$

Where (X;Y) represents the set of all combinations of word pairs of BP. For an individual word pair (x, y), Equation 12 can be simplified as follows:

$$I ( x ; y ) = p ( x , y ) log \frac{p ( x , y )}{p ( x ) p ( y )} \qquad Eq . 13$$

where, x and y are individual words in the lexicon Σ. As with the translation model and the language model, a training corpus of Chinese couplets can be used to estimate the mutual information parameters as follows:

$$\begin{matrix}p ( x , y ) = p ( x ) p ( y \vert x ) & Eq . 14 \\ p ( x ) = \frac{CountSen ( x )}{NumTotalSen} & Eq . 15 \\ p ( y ) = \frac{CountSen ( y )}{NumTotalSen} & Eq . 16 \\ p ( y \vert x ) = \frac{CountCoocur ( x , y )}{CountSen ( x )} & Eq . 17\end{matrix}$$

where CountSen(x) is the number of sentences (including both first and second scroll sentences) including word x; CountSen(y) is the number of sentences including word y; CountCoocur(x,y) is the number of sentences (either a first scroll sentence or a second scroll sentence) containing both x and y; and NumTotalSen is the total number of first scroll sentence and second scroll sentences in the training data or corpus.
Augmentation of the Lexical Knowledge Base

Referring back to FIGS. 3 and 5 introduced above, FIG. 3 illustrates a system that can perform step 202 illustrated in FIG. 2. FIG. 5 illustrates a flow diagram of augmentation of the lexical knowledge base in accordance with the present inventions and corresponds generally with FIG. 3.

At step 502, lexical knowledge base construction module 300 receives Chinese couplet corpus 302. Chinese couplet corpus 302 can be received from any of the input devices described above as well as from any of the data storage devices described above.

In most embodiments, Chinese couplet corpus 302 comprises Chinese couplets such as currently exist in Chinese literature. For example, some forms of Tang Dynasty poetry contain large numbers of Chinese couplets that can be appropriate corpus. Chinese couplet corpus 302 can be obtained from both publications and web resources. In an actual reduction to practice, more than 40,000 Chinese couplets were obtained from various Chinese literature resources for use as training corpus or data. At step 504, word segmentation module 304 performs word segmentation on Chinese corpus 302. Typically, word segmentation is performed by using parser 305 and accessing lexicon 306 of words existing in the language of corpus 302.

At step 506, counter 308 counts words uᵣ (r=1, 2, . . . , m) in first scroll sentences that map directly to a corresponding word bᵢ in second scroll sentences as indicated at 310. At step 508, counter 308 counts unigrams bᵢ, bigrams bᵢ₋₁, bᵢ, and trigrams bᵢ₋₂, bᵢ₋₁, bᵢ as indicated at 312. Finally, at step 509, counter 308 counts all sentences (both first and second scroll sentences) having individual words x or y as well as co-occurrences of pairs of words x and y as indicated at 314. Count information 310, 312, and 314 are input to parameter estimation module 320 for further processing.

At step 510, as described in further detail above, word translation or correspondence probability trainer 322 estimates translation model 360 having probability values or scores p(uᵣ|bᵢ) as indicated at 326. In most embodiments, trainer 322 includes smoothing module 324 that accesses lexicon 306 to smooth the probability values 326 of translation model 360.

At step 512, lexical knowledge base construction module 300 constructs translation dictionary or mapping table 328 comprising a list of words and a set of one or more words that correspond to each word on the list. Mapping table 328 augments lexical knowledge base 301 as indicated at 358 as a lexical resource useful in later processing, in particular, second scroll sentence generation.

At step 514, as described in further detail above, word probability trainer 332 constructs language model 362 from probability information indicated at 336. Word probability trainer 332 can include smoothing module 334, which can smooth the probability distribution as described above.

At step 516, word association construction module 342 constructs word association model 364 including word association information 344. In many embodiments, such word association information can be used to generate mutual information scores between pairs of words as described above.

FIG. 4 is a block diagram of a system for performing second scroll sentence generation. FIG. 6 is a flow diagram of generating a second scroll sentence from a first scroll sentence and generally corresponds with FIG. 4.

Candidate Generation

At step 602, second scroll sentence generation module 400 receives first scroll sentence 402 from any of the input or storage devices described above. In most embodiments, first scroll sentence 402 is in Chinese and has the structure of a first scroll sentence of a typical Chinese couplet. At step 604, parser 305 parses first scroll sentence 402 to generate individual words u₁, u₂, . . . , uₙ as indicated at 404 where n is the number of words in first scroll sentence 402.

At step 606, candidate generation module 410 comprising word translation module 411 performs word look-up of each word uᵢ (i=1,2, . . . , n) in first scroll sentence 402 by accessing translation dictionary or mapping table 358. In most embodiments, mapping table 358 comprises list of words jᵢ where i=1,2, . . . , D and D is the number of entries in mapping table 358. Mapping table 358 also comprises a corresponding list of possible words kᵣ where r=1,2, . . . , m and m is the number of distinct entries for each word jᵢ. During look-up, word translation module 411 matches words uᵢ with entries jᵢ in mapping table 358 and links mapped words from beginning to end to form a “lattice”. Possible candidate second scroll sentences can be viewed as “paths” through the lattice. At step 608, word translation module 411 outputs a list of candidate second scroll sentences 412 that comprises some or all possible sequences or paths through the lattice.

Candidate Filtering

Filters 414, 416, 418 constrain candidate generation by applying certain linguistic rules (discussed below) that are generally followed by all Chinese couplets. It is noted that filters 414, 416, 418 can be used singly or in any combination or eliminated altogether as desired.

At step 610, word or character repetition filter 414 filters candidates 412 to constrain the number of candidates. Filter 414 filters candidates based on various rules relating to word or character repetition. One such rule requires that if there are first scroll sentences words that are identical, then the corresponding words in the second scroll sentence should be identical, too. For example, in a first scroll sentence: [symbol] , the characters [symbol] [symbol] are repeating. The legal second scroll sentence should also contain corresponding repeating words. For instance, a possible second sentence [symbol] would be legal because [symbol] , [symbol] , [symbol] correspond to [symbol] , [symbol] , [symbol] , respectively, and are repeating in the same way. The correspondence between repeating first and second scroll sentence words can be seen clearer with the following table.

[symbol]

[symbol]

[symbol]

[symbol]

[symbol]

[symbol]

[symbol]

Thus, the character [symbol] (in the first and last positions) appears two times in the first cross sentence and the corresponding character [symbol] also appears two times at the corresponding position in the second scroll sentence. The same is true for the correspondence between [symbol] and [symbol] (in the second and sixth position) as well as [symbol] and [symbol] (in the third and fifth position).

At step 612, non-repetition mapping filter 416 filters candidates 412 to further constrain candidate second scroll sentences. Thus, if there are no identical words in the first scroll sentence, then accordingly, the second scroll sentence should have no identical words. For instance, consider a first scroll sentence is [symbol] the first position character [symbol] is not repeated. Therefore, a proposed second scroll sentence [symbol] (where [symbol] in the first position appears twice) would be filtered.

At step 614, non-repetition of UP words filter 418 filters candidates 412 to further constrain number of candidates 412. Filter 418 ensures that words appearing in first scroll sentence 402 do not appear again in a second scroll sentence. For instance, consider a first scroll sentence [symbol] . A second sentence [symbol] (where the character [symbol] appears in both the first and second scroll sentences) would be filters for violating the rule that characters appearing in the first scroll sentence should not appear in the second scroll sentences and thus be filtered.

Similarly, filter 418 can filter proposed second scroll sentence among candidates 412 if a word in the proposed second scroll sentence has the same or similar pronunciation as the corresponding word in the first scroll sentence. For instance, consider the first scroll sentence is [symbol] . A second scroll sentence [symbol] because [symbol] in the fifth position has a similar to the character [symbol] in the fifth position of the first scroll sentence.

Viterbi Decoding and Candidate Re-Ranking

Viterbi decoding is well-known in speech recognition applications. At step 616, Viterbi decoder 420 accesses language model 362 and translation model 360 and generates N-best candidates 422 from the lattice generated above. It is noted that for a particular HMM, a Viterbi algorithm is used to find probable paths or sequences of words in the second scroll sentence (i.e. hidden states) given sequence of words in the first scroll sentence (i.e. observed states).

At step 618, candidate selection module 430 calculates feature functions comprising at least some of word translation model 360, language model 362, and word association information 364 as indicated at 432. Then ME model 433 is used to re-rank N-best candidates 422 to generate re-ranked candidates 434. The highest ranked candidate is labeled BP* as indicated at 436. At step 620, re-ranked candidates 434 and most probable second scroll sentence 436 are output, possibly to an application layer or further processing.

It is noted that re-ranking could be viewed as a classification process that selects the acceptable sentences and excludes the unaccepted candidates. In most embodiments, re-ranking is performed with a Maximum Entropy (ME) model with the following features:
1. language model score computed with using the following equation (Equation 3 above):

$${h}_{1} = p ( UP \vert BP ) = {\prod }_{i = 1}^{n} p ( {u}_{i} \vert {b}_{i} ) ;$$
2. translation model score computed with the following equation (Equation 8 above):

$${h}_{2} = p ( BP ) = p ( {b}_{1} ) \times p ( {b}_{2} \vert {b}_{1} ) {\prod }_{i = 1}^{n} p ( {b}_{i} \vert {b}_{i - 1} , {b}_{i - 2} ) ; and$$
3. mutual information score (MI) score computed with the following equation (Equation 12 above):

$${h}_{3} = I ( X ; Y ) = {\sum }_{x}^{} {\sum }_{y}^{} p ( x , y ) log \frac{p ( x , y )}{p ( x ) p ( y )} \qquad Eq . 18$$

The ME model is expressed as:

$$P ( BP \vert UP ) = {p}_{{λ}_{1}^{M}} ( BP \vert UP ) = \frac{exp [ {\sum }_{m = 1}^{M} {λ}_{m} {h}_{m} ( BP , UP ) ]}{{\sum }_{BP}^{} exp [ {\sum }_{m = 1}^{M} {λ}_{m} {h}_{m} ( BP , UP ) ]} \qquad Eq . 19$$

where hₘ represents features, m is the number of features, BP are the candidates of second scroll sentence, and UP is the first scroll sentence. The coefficients λₘ of different features are trained with the perceptron method as discussed in more detail below.

However, training data is needed to train the coefficients or parameters λ={λ₁, λ₂ . . . λₘ}. In practice, for 100 test first scroll sentences, the HMM model was used to generate the N-Best results, where N was set at 100. Human operators then annotated the appropriateness of the generate second scroll sentence by labeling accepted candidates with “1” and unacceptable candidates with “−1” as follows:

| Top-N candidates (only list | | | | Accept |
|---|---|---|---|---|
| some examples) | Featue1 | Feature2 | Feature3 | or not |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | +1 |
| [symbol] | . . . | . . . | . . . | +1 |
| [symbol] | . . . | . . . | . . . | +1 |
| [symbol] | . . . | . . . | . . . | +1 |
| [symbol] | . . . | . . . | . . . | +1 |
| . . . | . . . | . . . | . . . | . . . |

### The training examples

Each line represents a training sample. The ith sample can be denoted as (xᵢ,yᵢ), where xᵢ is the set of features, and yᵢ is the classification result (+1 and −1). Then, the perceptron algorithm can be used to train the classifiers. The table below describes the perceptron algorithm, which is used in most embodiments:

Given a training set S={(xᵢ,yᵢ)}ᵢ₌₁^{N}, the training algorithm is below.

```
λ [symbol] 0
Repeat
  For i = 1,...N
    If yᵢλ • xᵢ ≦ 0
      λ [symbol] λ + ηyᵢxᵢ
```

Until there are no mistakes or the number of mistakes is within a certain threshold

### The parameter training method with perceptron algorithm

### AN EXAMPLE

Given the first scroll sentence, [symbol] the following table illustrates the major process of generating the second scroll sentences. First, with the HMM, the top 50 second scroll sentences (top 20 are listed below) are obtained. The score of the Viterbi decoder is listed on the right column. Then these candidates are re-ranked with mutual information. The score of the mutual information can be seen at the second column.

Step 1: The word segmentation result:

[symbol]

Step 2: The candidates of each words: (below only a list of five corresponding words for each word in the first scroll sentence are presented)

| | | | | | |
|---|---|---|---|---|---|
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| [symbol] | [symbol] | [symbol] | [symbol] | [symbol] | [symbol] |
| . . . | . . . | . . . | . . . | . . . | . . . |

### The translation candidates of each word in the first scroll sentence

Step 3: N-Best candidates are obtained via the HMM model

Step 4: re-ranking with the ME model (LM score, TM score and MI score)

| | Featue1 | Feature2 | Feature3 | Accepted? |
|---|---|---|---|---|
| Top-N candidates | (LM score) | (TM score) | (MI score) | (ME result) |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | −1 |
| [symbol] | . . . | . . . | . . . | +1 |
| [symbol] | . . . | . . . | . . . | +1 |
| [symbol] | . . . | . . . | . . . | +1 |
| [symbol] | . . . | . . . | . . . | +1 |
| [symbol] | . . . | . . . | . . . | +1 |
| . . . | . . . | . . . | . . . | . . . |

### The result of the ME model

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer readable medium including instructions readable by a computer which, when implemented, cause the computer to augment a lexical knowledge base, comprising the steps of:
receiving a corpus of couplets written in a natural language, each couplet comprising a first scroll sentence and a second scroll sentence;
parsing the couplet corpus into individual first scroll sentence words and second scroll sentence words; and
constructing a translation model comprising probability information associated with first scroll sentence words and corresponding second scroll sentence words.

2. The computer readable medium of claim 1, and further comprising:
mapping a list of second scroll sentence words to a corresponding set of first scroll sentence words in the couplet corpus; and
constructing a mapping table comprising the list of second scroll sentence words and corresponding sets of first scroll sentence words that can be mapped to listed second scroll sentence words.

3. The computer readable medium of claim 1, and further comprising constructing a language model of the second scroll sentence words comprising at least some of unigram, bigram, and trigram probability values.

4. The computer readable medium of claim 3, and further comprising constructing word association information comprising sentence counts of first and second scroll sentences in the couplet corpus, wherein the sentence counts comprise number of sentences having a word x, number of sentences having a word y, and number of sentences having a co-occurrence of word x and word y.

5. The computer readable medium of claim 3, and further comprising constructing a Hidden Markov Model using the translation model and the language model.

6. A computer readable medium including instructions readable by a computer which, when implemented, cause the computer to augment a lexical knowledge base, comprising the steps of:
receiving a first scroll sentence;
parsing the first scroll sentence into a sequence of words; and
accessing a mapping table comprising a list of second scroll sentence words and corresponding sets of first scroll sentence words that can be mapped to the listed second scroll sentence words.

7. The computer readable medium of claim 6, and further comprising constructing a lattice of candidate second scroll sentences using the word sequence of the first scroll sentence and the mapping table.

8. The computer readable medium of claim 7, and further comprising:
constraining the number of candidate second scroll sentences using at least one of a word or character repetition filter; a non-repetition mapping filter; and a non-repetition of words in the first scroll sentence filter.

9. The computer readable medium of claim 7, and further comprising generating a list of N-best candidate second scroll sentences from the lattice using a Viterbi decoder.

10. The computer readable medium of claim 8, and further comprising re-ranking the list of N-best candidates using a Maximum Entropy Model.

11. The computer readable medium of claim 10, wherein re-ranking comprising calculating feature functions comprising at least some of translation model, and language model, and word association scores.

12. A method of generating second scrolls sentences from a first scroll sentence comprising the steps of:
receiving a first scroll sentence of a Chinese couplet;
parsing the first scroll sentence into a sequence of individual words;
performing look-up of each word in the sequence in a mapping table comprising Chinese word entries and corresponding sets of Chinese words; and
generating candidate second scroll sentences based on the sequence of the first scroll sentence words and the corresponding sets of Chinese words.

13. The method of claim 12, and further comprising constraining the number of candidate second scroll sentences by filtering based at least one of on word or character repetition, non-repetitive mapping, and non-repetitive words in first scroll sentences.

14. The method of claim 12, and further comprising applying a Viterbi algorithm to the candidate second scroll sentences to generate a list of N-best candidates.

15. The method of claim 14, and further comprising estimating feature functions for each candidate of the list of N-best candidates, wherein the feature functions comprise at least some of a language model, a word translation model, and word association information.

16. The method of claim 15, and further comprising using a Maximum Entropy model to re-rank the N-best candidates based on probability.

17. The method of claim 12, and further comprising constructing a word translation model comprising conditional probability values for a first scroll sentence word given a second scroll sentence word using a corpus of Chinese couplets.

18. The method of claim 17, and further comprising constructing a language model comprising unigram, bigram, and trigram probability values for second scroll sentence words in the Chinese corpus.

19. The method of claim 18, and further comprising estimating word association information comprising mutual information values for pairs of words in the training corpus.

20. The method of claim 12, and further comprising:
receiving a corpus of Chinese couplets;
parsing the Chinese couplets into individual words; and
mapping a set of first scroll sentence words to for each of selected second scroll sentence words to construct the mapping table.
